(19) United States
(12) Patent Application Publication
(10) Pub. No.: US 2016/0000251 A1
(43) Pub. Date: Jan. 7, 2016

(54) STOVE SHUT OFF SYSTEM

(71) Applicants: Carla Mosley, Big Spring, TX (US); Anthony Martinez, Big Spring, TX (US)

(72) Inventors: Carla Mosley, Big Spring, TX (US); Anthony Martinez, Big Spring, TX (US)

(21) Appl. No.: 14/324,051

(22) Filed: Jul. 3, 2014

(51) Int. Cl. A47J 27/62

(52) U.S. Cl. CPC A47J 27/62

(57) ABSTRACT

The present application relates to a shut off system used to regulate the flow of energy to a cooking unit. The system includes an electronic device configured to selectively control the flow of energy to the cooking unit and to transmit and receive data. A flow rate sensor is used to detect the flow of energy to the cooking unit and transmit flow data to the electronic device. A motion sensor is used to detect motion adjacent the cooking unit and transmit motion data to the electronic device. An energy regulator receives command data from the electronic device to selectively interrupt the flow of energy to the cooking unit when no motion has been detected by the motion sensor for a predetermined and preselected time duration.

### BACKGROUND

1. Field of the Invention

The present application relates generally to stoves and ranges, and in particular, to an automatic safety shut off system.

2. Description of Related Art

Cooking food within conventional residential and commercial establishments typically includes a cooking unit, such as a stove. Stoves typically include both a cooktop surface for pots and pans and an oven for baking. Additionally, some cooking units separate the range and oven as stand-alone units. These cooking units produce heat through electrical current or through the use of a gaseous fuel, such as natural gas.

A typical problem with these units is that a user generally has to operate the controls to turn the heating elements on or to turn them off. Additionally, if a situation arises where the user is distracted or is removed from the cooking vicinity, resulting in the unsupervised cooking of food, the conventional cooking units continue to operate. This has the danger of causing house fires. It is understood that timers are sometimes associated with cooking units, however, timers are manually operated and not able to adjust to changing environmental conditions.

Additionally, a glucometer is known to be capable of communicating with one of a number of separate individual devices. Typically the results are processed by the glucometer and then transmitted to another device. This configuration still requires the carrying of an entire glucose meter. Another disadvantage of present glucometers is an inability of the clock to accurately represent the time of past test results. Incorrect times may result from static electricity, loss of power, or the failure to adjust during travel through multiple time zones.

A safer and more adaptive shut off system for cooking units is needed. Considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a representation of a shut off system according to the preferred embodiment of the present application in use with a cooking unit;

FIGS. 2A-2B are detailed representative views of the shut off system of FIG. 1;

FIGS. 3A-3B are detailed representative views of an alternative embodiment of the shut off system of FIG. 1;

FIGS. 4A-4B are detailed representative views of an alternative embodiment of the shut off system of FIG. 1;

FIGS. 5A-5B are detailed representative views of an alternative embodiment of the shut off system of FIG. 1;

FIGS. 6A-6B are detailed representative views of an alternative embodiment of the shut off system of FIGS. 3A-3B; and

FIG. 7 is a schematic of an alternative embodiment of an electronic device used in any of the systems of the preceding figures.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

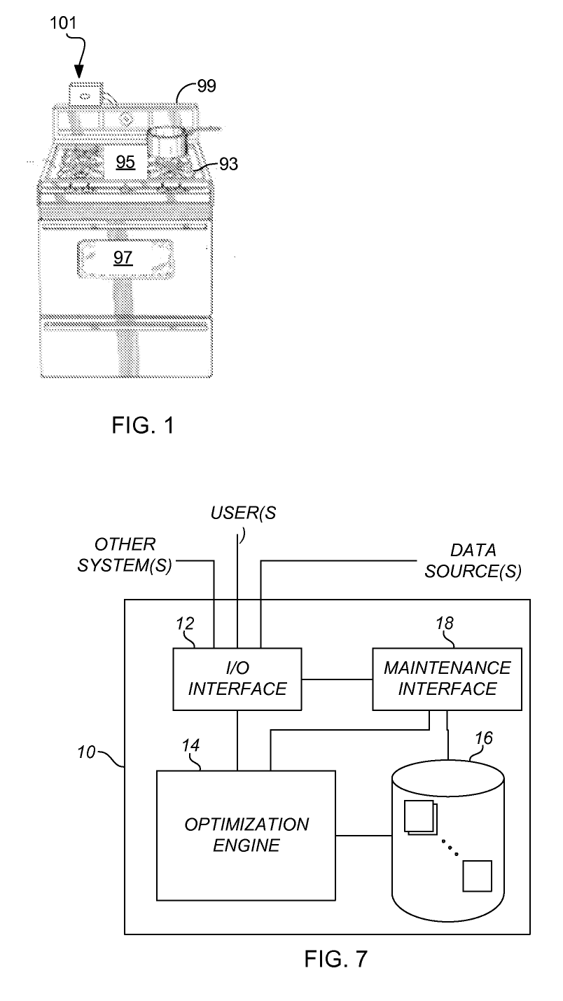

Referring now to FIG. 1 in the drawings, a shut off system is illustrated. Shut off system 101 is pictured in association with a cooking unit. An example of a cooking unit is stove 99. Stove 99 includes an oven 97 and a range top 95 as a single unit. Range top 95 has a plurality of heating elements 93 that are used to provide energy to cook food in pots or pans located externally to stove 99. Although not pictured, additional heating elements are located within oven 97 for baking. The internal heating elements within oven 97 provide energy to cook food internally within the body of stove 99. The cooking unit may also refer to stand alone units where the oven is separated from the range top. For example, a double oven or a cooktop range. It is understood that system 101 may operate with a separate oven and/or separate cooktop as well as a stove 99. For simplicity of this disclosure, the description will be based on stove 99 as the cooking unit. It is understood that system 101 will work equally with stand-alone cooking units.

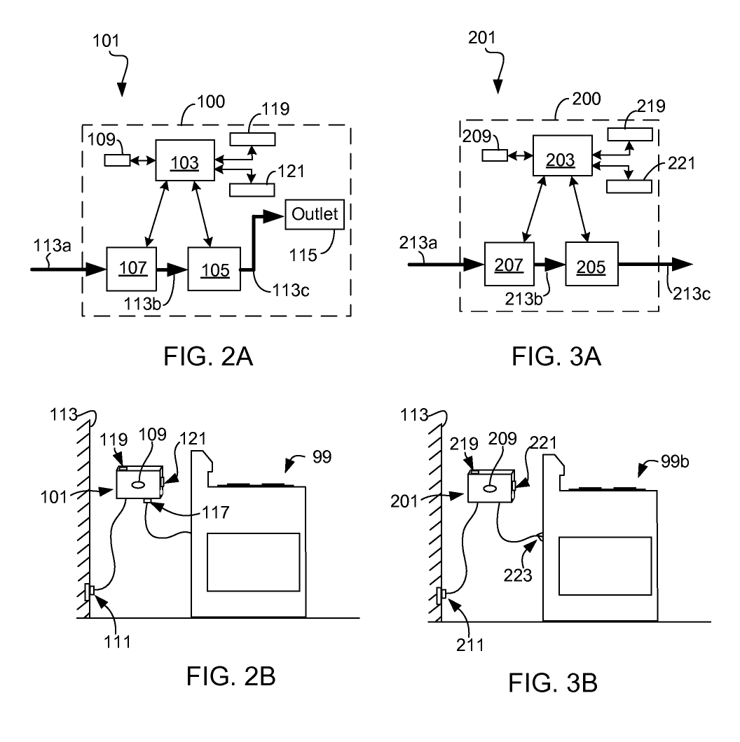

Referring now also to FIGS. 2A-2B in the drawings, system 101 is illustrated. System 101 is configured to selectively regulate the flow of energy to a cooking unit in order to prevent potential safety hazards. It is understood that situations arise where cooking food is left unattended. Short durations typically don't create much risk. However, there are times that cooking food is left unattended for longer durations of time. Long durations may lead to fires. System 101 monitors the presence of a user near the cooking unit when energy is provided to one or more heating elements 93. System 101 tracks the time duration of absences of the user via a motion sensor. The time duration denotes the period of time in which the cooking unit is unattended. When unattended for a selected duration, system 101 is configured to turn off power to one or more heating elements.

System 101 is configured to operate with either an electric stove, gas stove, or a gas/electric stove combination. System 101 also works with combinations of separate ovens and cooktops whether they use gas or electric energy to power the heating elements. System 101 receives power from a wall power source such as a wall outlet. System 101 uses a plug 111 to mate with a wall outlet. The outlet may either transfer 110V or 220V depending on the needs of the cooking unit.

System 101 includes an electronic device 103, a flow rate sensor 105, an energy regulator 107, and a motion sensor 109. These devices and sensors are housed within housing 100. Electronic device 103 is configured to selectively control the flow of energy to stove 99. Device 103 processes data received from flow rate sensor 105 and motion sensor 109 in order to selectively transmit command data to energy regulator 107.

In FIGS. 2A and 2B, stove 99 uses electrical energy to power the heating elements 93. Electrical energy is passed through plug 111 and is routed through energy regulator 107 and flow rate sensor 105. Arrows 113a-c denote the primary route of the electrical energy to stove 99. The remaining electrical components within system 101 receive electrical power from the plug 111 as well.

Electrical energy is passed to stove 99 via an outlet 115 coupled to housing 100. A plug 117 from stove 99 plugs into outlet 115. This simplifies the installation process for a user who uses a conventional stove 99. Typically only one 220V outlet is available near the wall. By utilizing outlet 115, system 101 provides an efficient method of powering stove 99 without adjustments to stove 99 or wall wiring.

Flow rate sensor 105 is configured to detect the flow of energy to stove 99 and transmit flow data to electronic device 103. An example of a flow rate sensor is a transformer configured to detect current and voltage through a wire. Electronic device 103 receives this flow data and processes it in order to generate the command data. It is understood that cooking units typically draw a certain amount of energy in order to power internal electronics, such as clocks and timers for example. Electronic device 103 is configured to recognize the difference between the flow of energy to power the internal electronics of stove 99 and the flow of energy to power heating elements 93.

Motion sensor 109 is configured to detect motion adjacent stove 99 and transmit motion data to electronic device 103. Motion sensor 109 is coupled to a portion of housing 100. Motion sensor 109 is located in a manner to provide a clear unobstructed view of the immediate vicinity around stove 99. As seen in FIG. 1, motion sensor 109 and system 101 are located slightly above stove 99 along the back edge. System 101 may rest on top of an upper portion of stove 99 or may be configured to mount directly to wall 113. Other locations may be on the counter or along the underside of an upper cabinet. Although motion sensor 109 is depicted as being coupled to housing 100, it is understood that motion sensor may be remote from housing 100 while remaining in electrical communication (wired or wireless) with electronic device 103. This embodiment would permit the user to more easily disguise the location of the motion sensor. Additionally, it is understood that the projected field of view and sensitivity of motion sensor 109 may be adjusted by a user.

Energy regulator 107 is configured to receive command data from electronic device 103 to selectively interrupt the flow of energy to the cooking unit, stove 99. Energy regulator 107 is a power transistor, or a field effect power transistor for example. Regulator 107 is able to stop the flow of energy through system 101 to stove 99 upon the direction of electronic device 103. During normal operation, regulator 107 permits uninterrupted flow. Only upon command data from electronic device 103 being transmitted to regulator 107 to interrupt flow will there be any cessation or regulation of energy flow to stove 99.

When flow rate sensor data communicates that there is sufficient energy draw from stove 99 to a heating element 93, electronic device 103 begins receiving motion data from motion sensor 109. If motion sensor 109 fails to detect motion for a predetermined time duration while the flow rate data denotes an operational heating element, electronic device 103 transmits command data to regulator 107 to interrupt the flow of energy to stove 99.

System 101 further includes a reset 119 to permit a user to reset and “open” regulator 107, such that an unrestricted flow of energy is permitted to stove 99. In general, reset 119 adjusts the position of regulator 107 so as to permit the flow of energy once more. System 101 may further include a selectable timer 121. Timer 121 is in two-way communication with electronic device 103 to track the duration of undetected motion adjacent the cooking unit. The prescribed time limit duration permitted by system 101 is adjustable by a user. The timer may be mechanical to permit a user to select preset time durations my moving a switch. In other embodiments, timer may be automated or electronically controlled and incorporated directly within device 103. This latest embodiment of timer 121 may permit infinite adjustment setting for allowed time durations without detected movement.

Referring now also to FIGS. 3A and 3B in the drawings, an alternative embodiment of system 101 is illustrated. System 201 is an alternative embodiment of system 101 and has the same form and functions as that of system 101. System 201 includes an electronic device 203, a flow rate sensor 205, an energy regulator 207, and a motion sensor 209. These devices and sensors are housed within housing 200. Electronic device 203 is configured to selectively control the flow of energy to stove 99b. Device 203 processes data received from flow rate sensor 209 and motion sensor 209 in order to selectively transmit command data to energy regulator 207. The forms, functions, and features of flow System 201 operates with stove 99b. Stove 99b is similar in form and function to stove 99 except that stove 99b fails to have plug 117.

The way electrical energy is passed from system 201 to stove 99b differs. Whereas in system 101, outlet 115 was used, it is understood that some cooking units may not be equipped with a plug. In those embodiments, wiring from flow rate sensor 205 may extend externally from housing 200 and couple directly to the back of stove 99b. As seen in FIG. 3B, a three-prong connector 223 is provided at the end of the wire and is releasably coupled to stove 99b. This creates a hard-wired connection as opposed to the plugged connection in FIGS. 2A and 2B.

Stove 99b uses electrical energy to power the heating elements. Electrical energy is passed through plug 211 and is routed through energy regulator 207 and flow rate sensor 205. Arrows 213a-c denote the primary route of the electrical energy to stove 99b. The remaining electrical components within system 201 receive electrical power from the plug 211 as well.

The forms, functions, and features of flow rate sensor 205, energy regulator 207, motion sensor 209, electronic device 203, timer 221, and reset 219 are similar to that of flow rate sensor 105, energy regulator 107, motion sensor 109, electronic device 103, timer 121, and reset 119 of FIGS. 2A and 2B. The disclosure of such forms, features, and functions are equally applicable to the corresponding elements in FIGS. 3A and 3B.

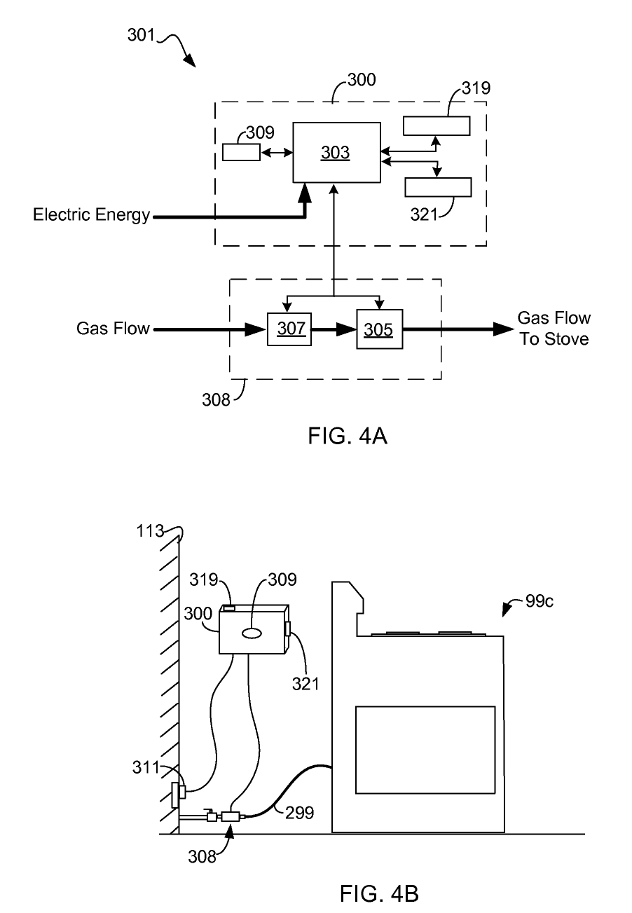

Referring now also to FIGS. 4A and 4B in the drawings, an alternative embodiment of system 101 is illustrated for use with a gas stove. System 301 is configured to operate with a stove 99c similar in form and function to that of stove 99 except that stove 99c uses natural gas with a heating element. System 301 has the same form and functions as that of system 101 except that system 301 is configured to regulate the passage of natural gas as the form of energy as opposed to electricity as seen in FIGS. 2A-3B.

The use of natural gas as opposed to electricity as the power source for the heating elements necessitates a change in the general configuration. System 301 includes an electronic device 303, a flow rate sensor 305, an energy regulator 307, and a motion sensor 309, timer 321, and reset 319 similar in form, functions, features and interactions to that of flow rate sensor 105, energy regulator 107, motion sensor 109, electronic device 103, timer 121, and reset 119 of FIGS. 2A and 2B.

In this embodiment, energy regulator 307 is an electronic control valve used to selectively interrupt the flow of natural gas to line 299. Flow rate sensor 305 is a flow rate sensor configured to monitor and detect the movement and passage of gas through line 299. Additionally, energy regulator 307 and flow rate sensor 305 are removed from main housing 300 and placed externally into a valve body 308.

Valve body 308 is in electrical communication with the devices and sensors within housing 300. Valve body 308 is inserted between gas line 299 and the gas line extending away from the wall. Flow rate sensor 309 continues to monitor or detect the flow rate of natural gas to gas line 299. Flow data is sent to electronic device 303 regarding the amount and rate of flow. Energy regulator 307 is configured to receive the command data from electronic device 303 and selectively interrupt the flow of natural gas to gas line 299.

Power is provided to stove 99c via a separate plug connection to an outlet in the wall (not shown). Additional embodiments may still permit for an outlet, like outlet 115 in FIG. 1, in order to provide electric power to operate the electronics of stove 99c. System 301 is configured to also plug into the wall with plug 311 and may work with either 110V or 220V outlets.

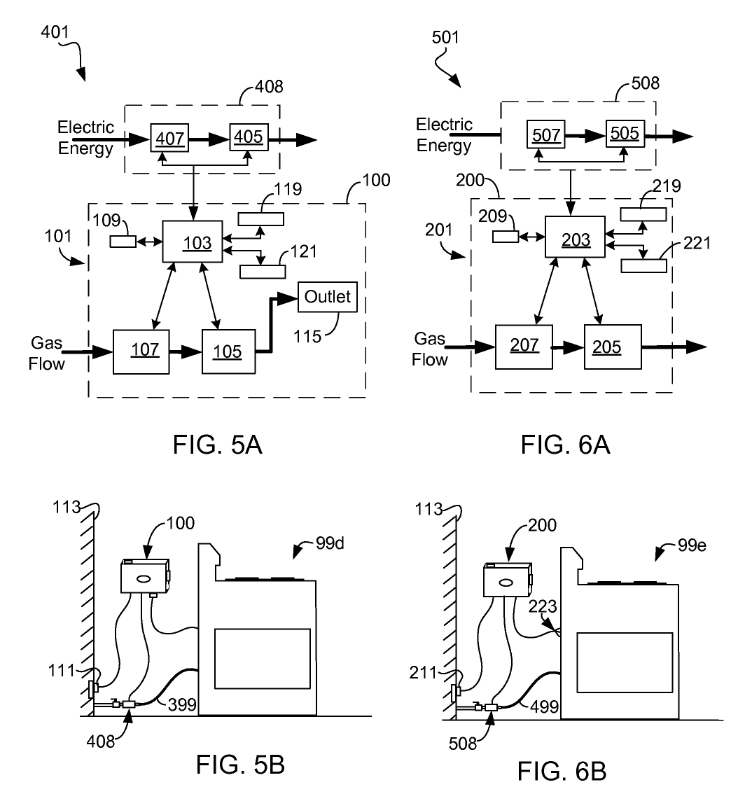

Referring now also to FIGS. 5A and 5B in the drawings, an alternative embodiment of system 101 is illustrated. System 401 is configured to operate with a stove 99d similar in form and function to that of stove 99 except that stove 99d uses natural gas and electric heating elements. The configuration of system 401 used with stove 99d also is operable with stand-alone combinations with a cooktop using gas and a separate oven using electricity, for example. System 401 has the same form and functions as that of system 101 except that system 401 is configured to regulate the passage of natural gas as well.

System 401 includes system 101 as well as an additional valve body 408 having a gas flow sensor 405 and energy regulator 407. System 101 differs in that electronic device 103 is now also configured to be in two way communication with valve body 408. Valve body 408 is similar in form and function to valve body 308 in FIGS. 4A and 4B. Additionally, command data is transmitted to regulator 407 as well as regulator 107. Flow rate sensor 405 transmits flow data to electronic device 103 regarding the flow of natural gas through line 399. Electronic device 103 in system 401 is configured to selectively interrupt the flow of either electricity or natural gas. Timer 119 is also able to be set to separate predetermined time durations for each regulator (407 and/or 107). An advantage to this system is that an oven may be able to remain in operation when the range or cooktop is turned off. Likewise a user is able to selectively reset either regulator.

Referring now also to FIGS. 6A and 6B in the drawings, an alternative embodiment of system 301 is illustrated. System 501 is configured to operate with a stove 99e similar in form and function to that of stove 99b except that stove 99e uses natural gas and electric heating elements. The configuration of system 501 used with stove 99e also is operable with stand-alone combinations with a cooktop using gas and a separate oven using electricity, for example. System 501 has the same form and functions as that of system 201 except that system 501 is configured to regulate the passage of natural gas as well.

System 501 includes system 201 as well as an additional valve body 508 having a gas flow sensor 505 and energy regulator 507. System 201 differs in that electronic device 203 is now also configured to be in two way communication with valve body 508. Valve body 508 is similar in form and function to valve body 308 in FIGS. 4A and 4B. Additionally, command data is transmitted to regulator 507 as well as regulator 207. Flow rate sensor 405 transmits flow data to electronic device 203 regarding the flow of natural gas through line 499. Electronic device 203 in system 501 is configured to selectively interrupt the flow of either electricity or natural gas. Timer 219 is also able to be set to separate predetermined time durations for each regulator (507 and/or 207). An advantage to this system is that an oven may be able to remain in operation when the range or cooktop is turned off. Likewise a user is able to selectively reset either regulator.

Although described as being a separate system from that of the cooking unit, it is understood that any of the systems described previously may be fully integrated into any of the cooking units described. A cooking unit such as stove 99, a stand-alone range cooktop and stand-alone oven may incorporate one or more of the devices, elements, sensors, and regulators of the previous systems to safely regulate the flow of energy to a heating element. The individual housings for each element would not necessarily be utilized but the functions and communications of each element, sensor, device, and regulator within each system are available to be used. The electronic device may be incorporated into existing circuitry of the cooking unit. It is also understood that the electronic device may regulate multiple heating elements individually with separate flow meters and energy regulators for each heating element.

An additional feature for each of the systems herein described is the ability to function wirelessly with each of the sensors, elements, and regulators. In addition, each of the systems may further include a battery to provide power to any portion of the systems described as opposed to using power from the outlet. Furthermore, it is contemplated that any of the above electronic devices may be configured to operate wirelessly with a user to a smartphone or tablet or remote computerized device. This would allow the user remote wireless control of temperature setting for any heating element. Remote temperature control would be feasible.

Referring now also to FIG. 7 in the drawing. FIG. 7 illustrates an exemplary electronic device 10 that may be used within any of the previously described systems so as to permit wireless functionality for a user. FIG. 7 is used to illustrate additional features and functionality of previously described electronic devices 103,203,303 in systems 101-501. The electronic device 10 includes an input/output (I/O) interface 12, an optimization engine 14, a database 16, and a maintenance interface 18. Alternative embodiments can combine or distribute the input/output (I/O) interface 12, optimization engine 14, database 16, and maintenance interface 18 as desired. Embodiments of the electronic device 10 can include one or more processors and memories configured for performing tasks described herein. This can include, for example, a computer having a central processing unit (CPU) and non-volatile memory that stores software instructions for instructing the CPU to perform at least some of the tasks described herein. This can also include, for example, two or more devices or computers that are in communication via a computerized network, where one or more of the devices or computers includes a CPU and non-volatile memory, and one or more of the non-volatile memory stores software instructions for instructing any of the CPU(s) to perform any of the tasks described herein. Thus, while the exemplary embodiment is described in terms of a discrete device, it should be appreciated that this description is non-limiting, and that the present description applies equally to numerous other arrangements involving one or more devices performing tasks distributed in any way among the one or more machines. Furthermore the devices or computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the electronic device 10. The I/O interface 12 can be configured for allowing one or more users to input information to the electronic device 10 via any known input device. Examples can include a keyboard, mouse, touch screen, microphone, and/or any other desired input device. The I/O interface 12 can be configured for allowing one or more users to receive information output from the electronic device 10 via any known output device. Examples can include a display monitor, a printer, a speaker, and/or any other desired output device. The I/O interface 12 can be configured for allowing other systems to communicate with the electronic device 10. For example, the I/O interface 12 can allow one or more remote devices or computers to access information, input information, and/or remotely instruct the electronic device 10 to perform one or more of the tasks described herein. The I/O interface 12 can be configured for allowing communication with one or more remote data sources. For example, the I/O interface 12 can allow one or more remote data source(s) to access information, input information, and/or remotely instruct the electronic device 10 to perform one or more of the tasks described herein.

The database 16 provides persistent data storage for electronic device 10. While the term “database” is primarily used, a memory or other suitable data storage arrangement may provide the functionality of the database 16. In alternative embodiments, the database 16 can be integral to or separate from the electronic device 10 and can operate on one or more computers. The database 16 preferably provides non-volatile data storage for any information suitable to support the operation of the electronic device 10.

The maintenance interface 18 is configured to allow users to maintain desired operation of the electronic device 10. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the optimization engine 14 and/or the I/O interface 12. This can include, for example, software updates and/or administrative tasks such as security management and/or adjustment of certain tolerance settings.

The current application has many advantages over the prior art including at least the following: (1) increased safety within homes; (2) automatic shut off of a cooking unit if left unattended; (3) remote and wireless functionality; and (4) simple integration with existing cooking units.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A shut off system, comprising:
an electronic device configured to selectively control the flow of energy to a cooking unit, the electronic device being configured to transmit and receive data;
a flow rate sensor configured to detect the flow of energy to the cooking unit and transmit flow data to the electronic device;
a motion sensor configured to detect motion adjacent the cooking unit and transmit motion data to the electronic device; and
an energy regulator configured to receive command data from the electronic device to selectively interrupt the flow of energy to the cooking unit;
wherein the electronic device transmits the command data to the energy regulator to shut off the flow of energy to the cooking unit when no motion is detected adjacent the cooking unit for a prescribed time limit.

2. The shut off system of claim 1, wherein the cooking unit is at least one of a stove, cooktop, and oven.

3. The shut off system of claim 1, wherein the cooking unit receives electrical power.

4. The shut off system of claim 3, further comprising:
an outlet, the outlet configured to accept a plug from the cooking unit to receive electrical power.

5. The shut off system of claim 4, wherein the cooking unit receives natural gas through the energy regulator and flow rate sensor.

6. The shut off system of claim 1, further comprising:
a timer in two-way communication with the electronic device to track the duration of undetected motion adjacent the cooking unit, communication between the timer and the electronic device occurs when energy flows to the cooking unit above a prescribed threshold.

7. The shut off system of claim 6, wherein the prescribed time limit for undetected motion is adjustable by a user.

8. The shut off system of claim 1, further comprising:
a reset configured to adjust the position of the energy regulator, so as to permit the flow of energy to the cooking unit.

9. The shut off system of claim 1, wherein the energy regulator is a power transistor and the flow rate sensor is a transformer, the transformer configured to detect electrical current and voltage through a wire.

10. The shut off system of claim 9, further comprising:
an outlet configured to releasably engage a plug coupled to the cooking unit, the outlet configured to pass electrical power to the cooking unit;
wherein electrical power passes through the power transistor and the transformer to the outlet.

11. The shut off system of claim 9, further comprising:
a secondary wire in communication with the transformer, the secondary wire extending to and releasably coupling to the cooking unit.

12. The shut off system of claim 1, wherein the energy regulator is an electronic control valve and the flow rate sensor detects the flow of gas through a gas line, the gas line directing the flow of gas to the cooking unit.

13. The shut off system of claim 12, further comprising:
an outlet configured to releasably engage a plug coupled to the cooking unit, the outlet configured to pass electrical power to the cooking unit.

14. The shut off system of claim 12, further comprising:
a secondary wire in communication with the transformer, the secondary wire extending to and releasably coupling to the cooking unit.

15. The shut off system of claim 1, wherein the motion sensor is coupled to a structure adjacent the cooking unit.

15. The shut off system of claim 1, wherein the energy regulator and flow rate sensor is configured to operate the flow of energy to a single heating element.

16. The shut off system of claim 1, wherein the electronic device is configured to regulate the flow of energy to each individual heating element separately.

17. The shut off system of claim 1, wherein the electronic device is wirelessly operated by a user.

18. The shut off system of claim 17, wherein the energy regulator can incrementally decrease and increase the flow of energy to the cooking unit as instructed by the user via wireless communications with the electronic device.
